(19) United States
(12) Patent Application Publication
(10) Pub. No.: US 2015/0327509 A1
(43) Pub. Date: Nov. 19, 2015

(54) SYSTEMS AND METHODS FOR TEMPORARILY RESTRAINING AN ANIMAL

(71) Applicant: Derik Eugene Hickling, Seattle, WA (US)

(72) Inventor: Derik Eugene Hickling, Seattle, WA (US)

(21) Appl. No.: 14/694,882

(22) Filed: Apr. 23, 2015

Related U.S. Application Data
(60) Provisional application No. 61/994,959, filed on May 18, 2014.

(51) Int. Cl. A01K 1/04

(52) U.S. Cl. CPC A01K 1/04

(57) ABSTRACT

A portable method of restraining an animal that frees both hands of a user. System includes a rigid anchor and a carrier that can be rigid or flexible. The anchor is coupled with a lead or leash, and the carrier is separately coupled with the same lead or leash. The carrier has a socket that is substantially the same shape as the cross section of the anchor, and the anchor can be disposed through the socket, allowing the anchor to be carried by the leash and carrier. When the user needs both hands, the user can remove the anchor from the carrier and insert the anchor into the ground. Since the anchor is coupled with the leash, this will prevent the animal from leaving the area. When ready to continue, the user removes the anchor from the ground and returns it to the carrier.

### PRIORITY CLAIM

This application claims the benefit of U.S. provisional patent application No. 61/994,959, filed May 18, 2014. The foregoing application is incorporated in its entirety as if fully set forth herein.

### FIELD OF THE INVENTION

This invention relates generally to animal restraints, and, more specifically, to systems and methods of temporarily restraining an animal.

### BACKGROUND OF THE INVENTION

People walking animals on a lead or leash may need both hands to complete another task, such as picking up after the animal, retrieving something that they dropped, retrieving mail or a newspaper, etc. If the animal jerks on the lead or leash while the human is bent over, it can cause the human to tumble, causing injury. For these reasons and others, it is helpful to have a means by which the animal can be restrained while allowing the human to use both hands. The invention disclosed herein contains systems and methods for temporarily restraining an animal while allowing the use of both human hands.

### SUMMARY

This invention relates generally to animal restraints, and, more specifically, to systems and methods of temporarily restraining an animal. The system is comprised of an anchor and a carrier.

In some embodiments, the system for temporarily restraining an animal may be portable. In some embodiments, the system for restraining an animal may comprise an anchor, the anchor further comprising: a proximal end with a handle, and a distal end, wherein the distal end tapers to a point. In some embodiments, the system for restraining an animal may comprise a carrier, the carrier further comprising: a grip end, the grip end configured to mate with an animal leash; and an anchor end, the anchor end configured to removably receive the anchor.

In some embodiments, the anchor may comprise a T-shaped cross section. In some embodiments, the anchor may comprise a circular, square, triangular, x-shaped, or other shaped cross section. In some embodiments, the anchor may include a handle. In a further embodiment, the handle may be a loop.

In some embodiments, the carrier may comprise an anchor end containing a T-shaped cutout configured to removably receive the anchor. In some embodiments, the anchor end may contain a shape that is substantially the same as the cross-section of the anchor.

In some embodiments, the carrier may include a clip. In some embodiments, the clip may further comprise an open end and a closed end, wherein the area between the open end and the closed end contains a gap; and a plurality of opposing teeth evenly spaced throughout the gap between the open end and the closed end.

In some embodiments, the carrier may include a substantially flat surface; and a double-sided adhesive element, wherein one side of the adhesive is disposed on the substantially flat surface of the grip end.

In some embodiments, the system for restraining an animal may comprise an anchor, the anchor further comprising: a proximal end, wherein the proximal end forms a loop; a distal end, wherein the distal end tapers to a point; and a T-shaped cross section. In some embodiments, the system for restraining an animal may comprise a carrier, the carrier further comprising: a grip end with an open end and a closed end, wherein the distance between the open end and closed end contains a plurality of opposing nibs alternating with open space; and an anchor end, the anchor end containing a T-shaped cutout configured to removably receive the anchor.

The invention further comprises a method of temporarily restraining an animal, wherein the method is comprised of: carrying an anchor in a carrier, the carrier disposed on a surface of the animal leash; coupling the animal leash with a handle of the anchor; removing the anchor from the carrier; inserting a tapered end of the anchor into the ground; removing the anchor from the ground; and returning the anchor to the carrier disposed on the surface of the animal leash.

### BRIEF DESCRIPTION OF THE DRAWINGS

Certain embodiments of the present invention are described in detail below with reference to the following drawings:

FIG. 1 is an isometric view of one embodiment of the system for temporarily restraining an animal.

FIG. 2 is an isometric view of one embodiment of the anchor.

FIG. 3a is a side view thereof.

FIG. 3b is a front view thereof.

FIG. 3c is a bottom view of the anchor.

FIG. 4 is an isometric view of one embodiment of the anchor carrier.

FIG. 5 is a front view thereof.

FIG. 6 is an isometric view of another embodiment of the system for temporarily restraining an animal.

FIG. 7 is an isometric view of an alternative embodiment of the anchor carrier.

FIG. 8a is a front view thereof.

FIG. 8b is a side view thereof.

### DETAILED DESCRIPTION

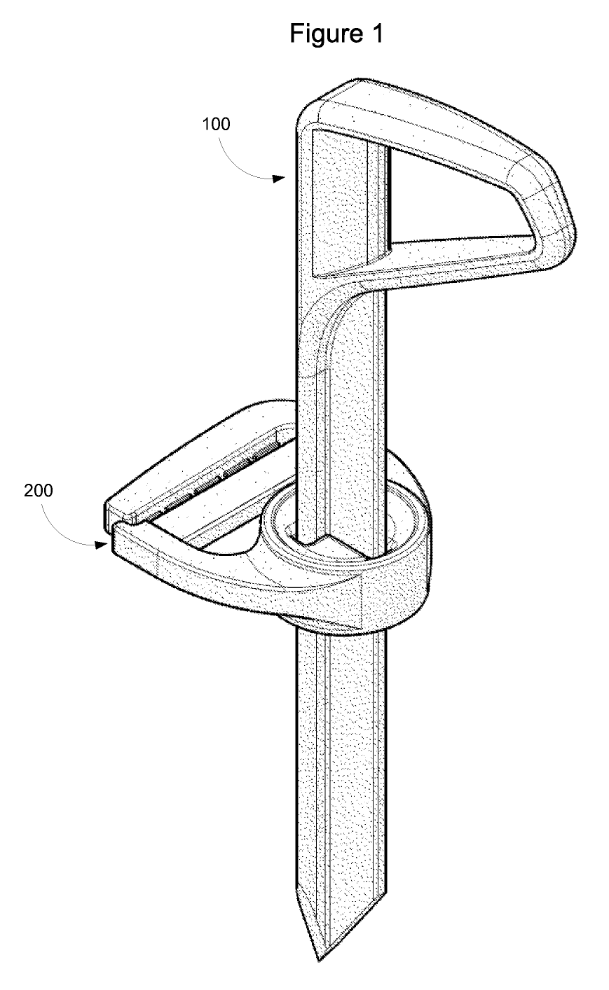

This invention relates generally to animal restraints, and, more specifically, to systems and methods of temporarily restraining an animal. Specific details of certain embodiments of the invention are set forth in the following description and in FIGS. 1-8 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

FIG. 1 is an isometric view of one embodiment of the system for temporarily restraining an animal. The system is comprised essentially of an anchor 100 and a carrier 200 or 300.

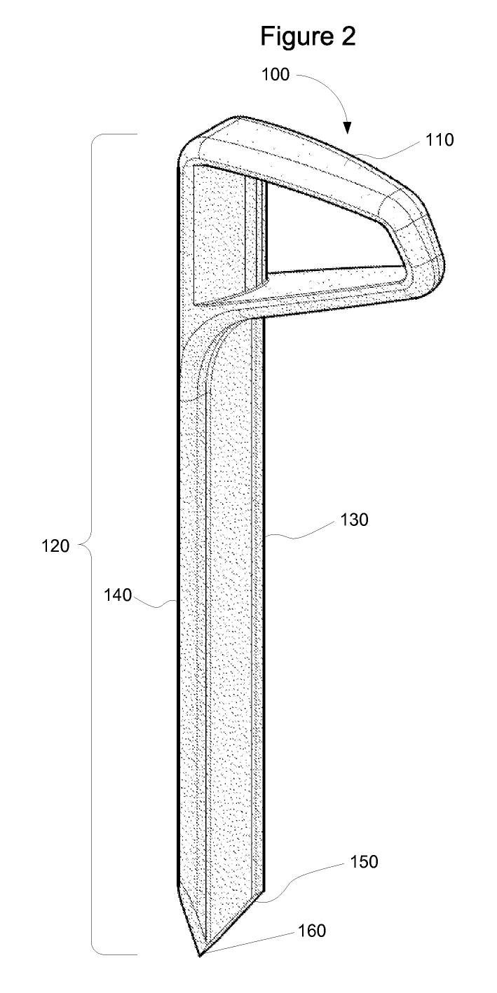

FIG. 1 shows one embodiment of an anchor 100 and a carrier 200. To temporarily restrain an animal, a user attaches an animal leash or lead to anchor 100. This can be accomplished in many manners, which are discussed in more detail further herein. In one manner of use, the user inserts anchor 100 into the ground, thereby freeing up the user's hands. In another manner of use, the user can position the leash or lead around a stationary object and pass the lead through the handle (depicted in FIG. 2) of anchor 100 to form a loop around the stationary object. When not being used to restrain an animal, anchor 100 is disposed through a socket in carrier 200, which can be removably attached to another part of the lead or leash. This is also discussed in more detail later herein.

FIG. 2 is an isometric view of one embodiment of the leash anchor 100. In some embodiments, the leash anchor may have a handle 110. In some embodiments, handle 110 may be disposed at the proximal end of body 120. In other embodiments, handle 110 may be disposed near the proximal end of body 120, wherein “near” is defined as between the proximal end of the body and one-half the length of anchor 100. In other embodiments, handle 110 may be disposed half way along the length of body 120. In some embodiments, handle 110 may be a loop. In some embodiments, handle 110 may be a loop with one end at the proximal end of body 120 and the other end near but not at the proximal end of body 120. In other embodiments, handle 110 may have two arms on opposing sides of body 120. In other embodiments, handle 110 may be a single arm. In some embodiments, handle 110 may be rigid. In other embodiments, handle 110 may be flexible. In other embodiments, handle 110 may be soft. In some embodiments, handle 100 may be comprised of the same material as body 120. In other embodiments, handle 110 may be a different material than body 120. In some embodiments, handle 110 may be seamlessly joined with body 120. In some embodiments, handle 110 and body 120 may be molded into a single piece. In other embodiments, handle 110 may be detachable. In some embodiments, handle 110 may be retractable. Two functions of handle 110 are to allow a user to grip anchor 100 and to provide a user with leverage when inserting or removing anchor 100. Handle 110 may be comprised of any number of materials without altering these functions. In some embodiments, handle 110 may include a gap through which a portion of a leash or lead can be disposed, thereby coupling handle 110 with the leash or lead. In other embodiments, the handle 110 may be coupled with the leash or lead via a standard clip such as a carabiner or gated hook.

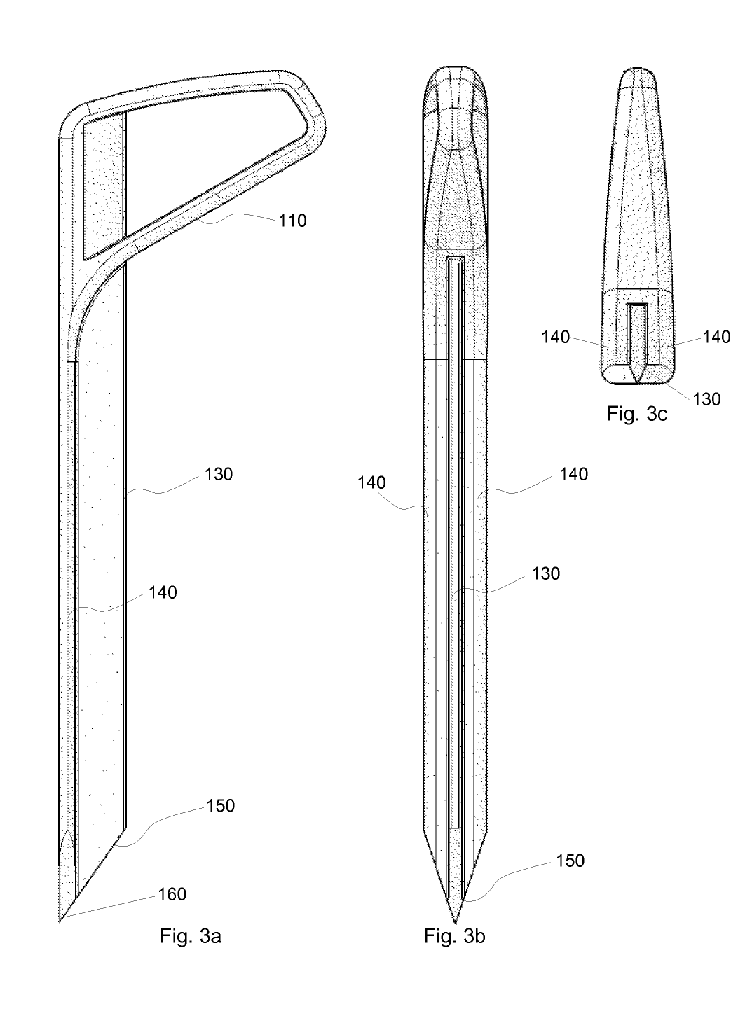

FIG. 3 shows multiple views of anchor 100. FIG. 3a is a side view of anchor 100. In some embodiments, anchor 100 may be comprised of a length of rigid material. In some embodiments, anchor 100 may have a T-shape cross section, with the leg 130 perpendicular to the arms 140. In this embodiment, leg 130 helps to prevent rotation of anchor 100, further lending to the restraint put on the animal. In other embodiments, anchor 100 may have a circular cross section, a square cross section, or a triangular cross section. In some embodiments, anchor 100 will begin to taper 150 near the distal end of anchor 100, wherein “near” is defined as between one-half the length of the anchor and the distal end of the anchor. In some embodiments, the taper will come to a point 160. FIGS. 3a and 3b shows that, in some embodiments, all of the leg 130 and arms 140 begin to taper 150. FIGS. 3b and 3c also show views of the embodiment wherein arms 140 and leg 150 form a T-shaped cross section.

In some embodiments, anchor 100 may be comprised of a substantially rigid material. In some embodiments, anchor 100 may be comprised of a material capable of withstanding significant stress forces, such as steel. In some embodiments, anchor 100 may be comprised of a material that is particularly lightweight, such as plastics. In some embodiments, anchor 100 may be comprised of a material that can withstand significant stress and is lightweight, such as titanium or composite materials. In such an embodiment, anchor 100 may weigh less than eight ounces and may be capable of withstanding up to 150 foot-pounds of force.

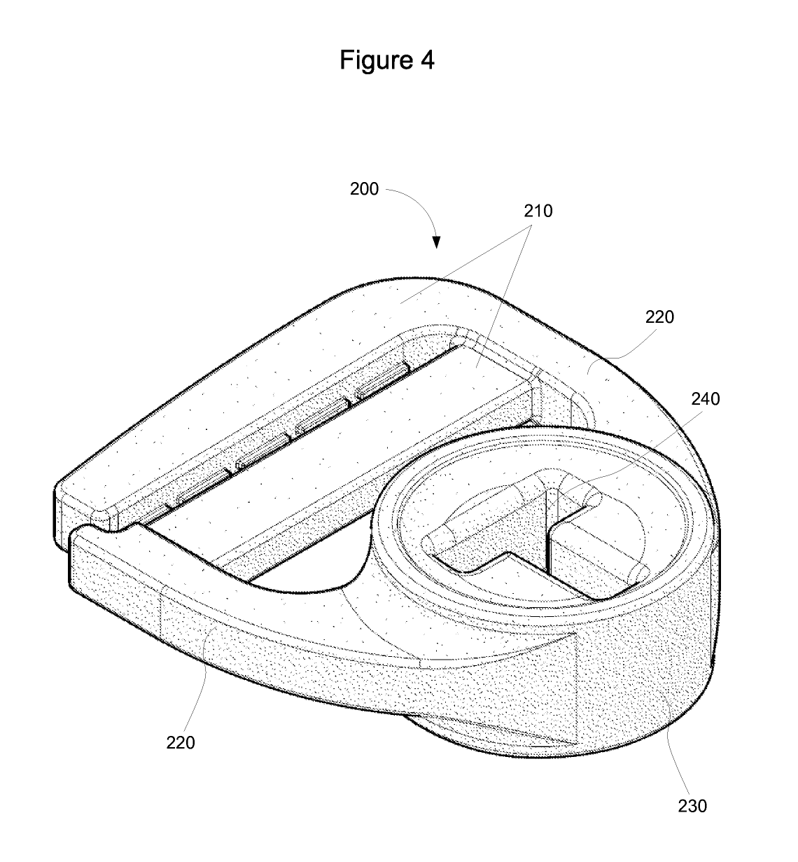

FIG. 4 is an isometric view of one embodiment of the carrier 200. In some embodiments, carrier 200 may be comprised of a clip 210. In some embodiments, carrier 200 may include arms 220 that extend to the cradle 230. In some embodiments, cradle 230 may include a socket 240, wherein the socket is substantially the same shape and size, though slightly larger, as anchor 100, allowing the anchor to be inserted into carrier 200 by way of the socket, as depicted in FIG. 1. In some embodiments, carrier 200 may be rigid, and may be comprised of hard plastic, metal, wood, or any other rigid material. In other embodiments, carrier 200 may be flexible or semi-flexible, and may be comprised of soft plastic, rubber, silicone, or other semi-flexible or flexible materials. In some embodiments, clip 210, arms 220, and cradle 230 may be molded into a single piece. In other embodiments, clip 210, arms 220, and cradle 230 may be independent pieces that are coupled. In some embodiments, these independent pieces may be removable or exchangeable.

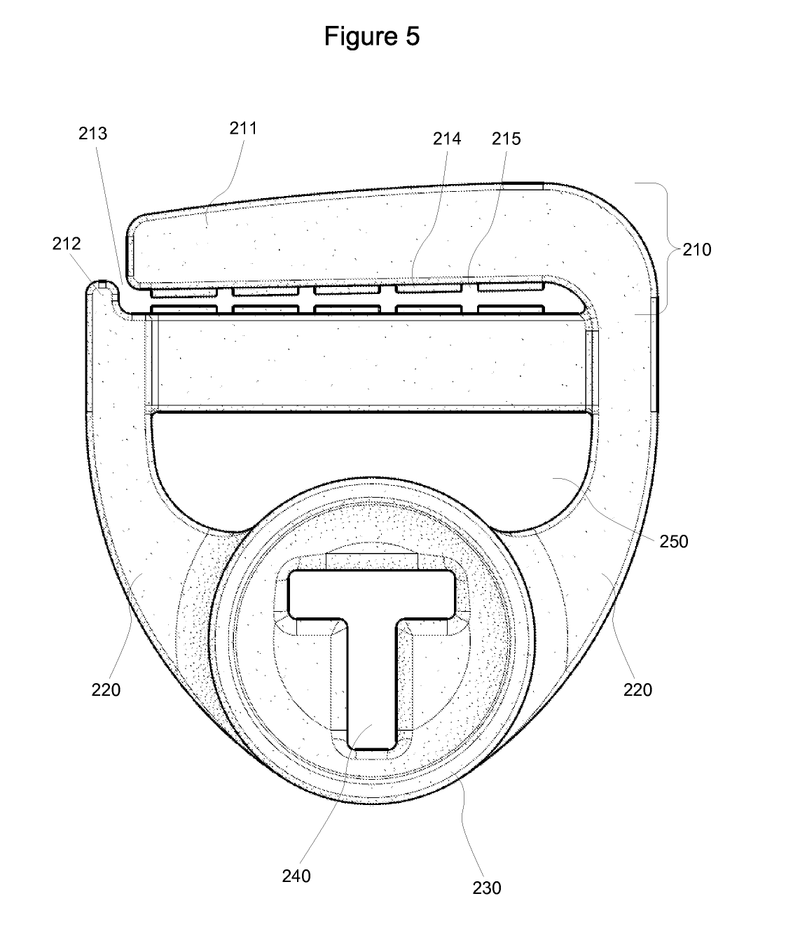

FIG. 5 is a front view of carrier 200. In some embodiments, clip 210 may be further comprised of an upper piece 211 and a lower piece 212. In some embodiments, the upper piece 211 and lower piece 212 may be joined on one end. In a further embodiment, there may be an opening 213 between upper piece 211 and lower piece 212 on the end opposite from the joined end. In some embodiments, upper piece 211 may include one or more teeth 214. In some embodiments, there may be one or more space 215 between the one or more teeth 214. In some embodiments, teeth 214 and spaces 215 may be disposed on the lower piece 212. In some embodiments, teeth 214 and spaces 215 may be disposed on both upper piece 211 and lower piece 212. One function of clip 210 is to allow the user to slide a portion of the leash or lead into the clip, allowing the clip to grip the leash or lead and thereby holding the carrier on the leash or lead. This can be accomplished without teeth 214, with teeth on the upper piece 211, the lower piece 212, or on both the upper and lower pieces without altering the function of clip 210. In some embodiments, carrier 200 may include a gap 250. In some embodiments, gap 250 allows a user to couple carrier 200 with a leash or lead via a chain, a zip-tie, or another two-ended coupler. To use this method, one end of the coupler would be disposed through gap 250 and then through the loop of a soft leash or the handle of a hard leash, and then coupled with the second end of the coupler.

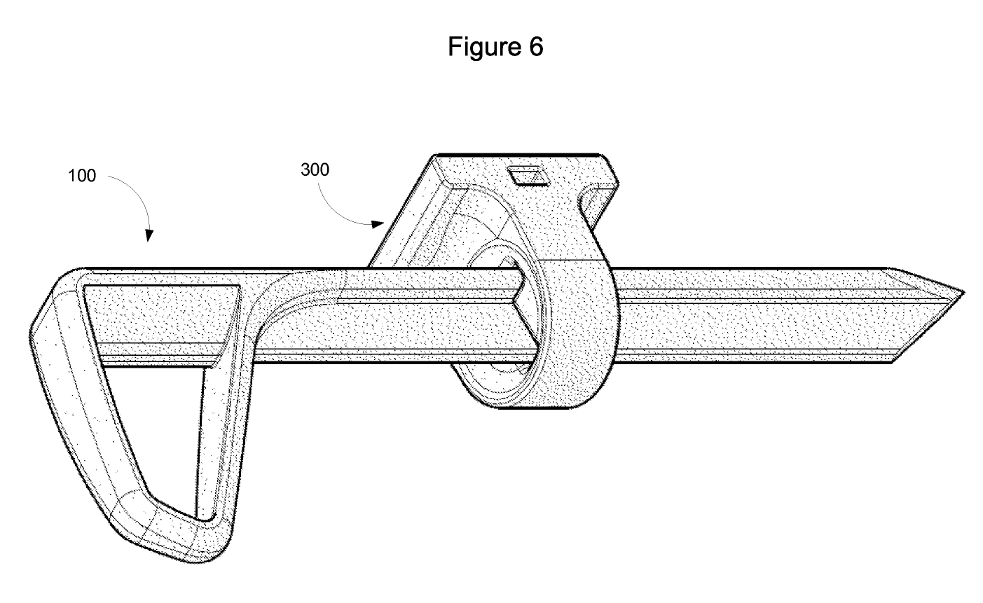

FIG. 6 is an isometric view of another embodiment of the system for temporarily restraining an animal. In this embodiment, anchor 100 is disposed through carrier 300, which is an alternative embodiment of the carrier.

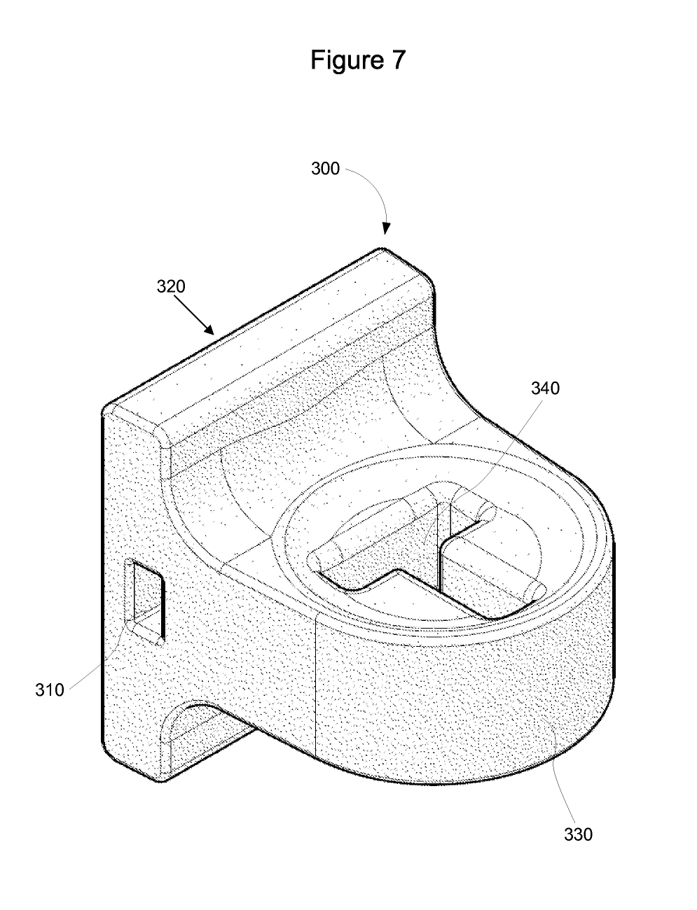

FIG. 7 is a depiction of the alternative embodiment carrier 300. In some embodiments, carrier 300 may include a coupler port 310. In some embodiments, port 310 extends through the width of carrier 300, such that a user could insert a chain, a string, a zip-tie, or other couplers on one side of the carrier and retrieve it on the other side. This would allow a user to use such a coupler to join carrier 310 with a leash or lead.

In some embodiments, carrier 300 may include a coupler surface 320. In these embodiments, surface 320 may be a flat or substantially flat surface prepared to receive an adhesive. In other embodiments, surface 320 may already have an adhesive material applied to it. In some embodiments, surface 320 may include a double-sided adhesive wherein a first side of the adhesive is adhered to the surface and a second side of the adhesive is protected by a film, a paper strip, or other protective means. In this embodiment, a user would remove the protective means to adhere carrier 300 to a surface. One function of surface 320 is to allow carrier 300 to be coupled with a substantially flat, rigid surface, such as the casing of a retractable leash.

In some embodiments, carrier 300 may include a cradle 330. In some embodiments, cradle 330 may include a socket 340, wherein the socket is substantially the same shape and size, though slightly larger, as anchor 100, allowing the anchor to be inserted into carrier 300 by way of the socket, as depicted in FIG. 6. In some embodiments, carrier 300 may be rigid, and may be comprised of hard plastic, metal, wood, or any other rigid material. In other embodiments, carrier 300 may be flexible or semi-flexible, and may be comprised of soft plastic, rubber, silicone, or other semi-flexible or flexible materials. In some embodiments, coupler gap 310, coupler surface 320, and cradle 330 may be molded into a single piece. In other embodiments, coupler gap 310, coupler surface 320, and cradle 330 may be independent pieces that are coupled. In some embodiments, these independent pieces may be removable or exchangeable.

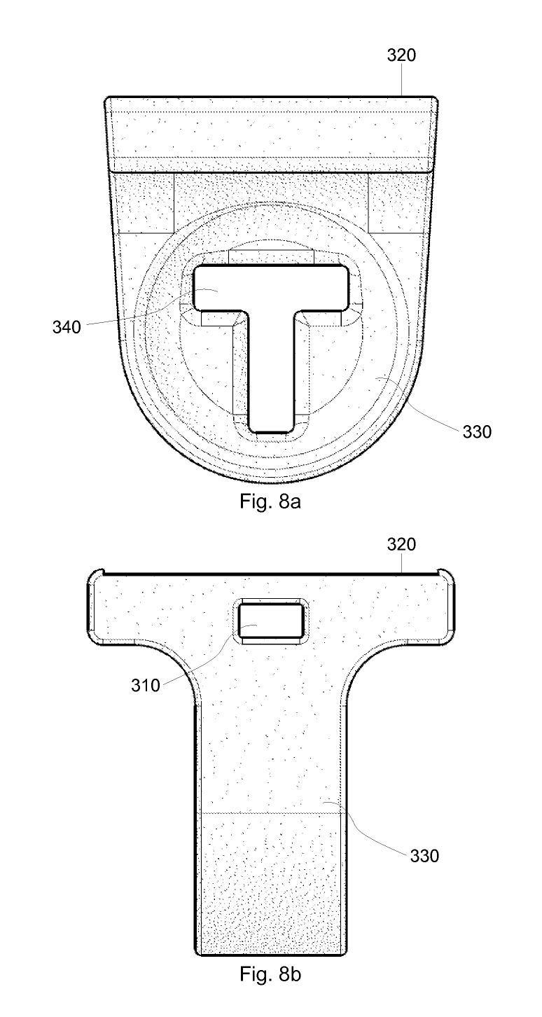

FIG. 8a is a front view of carrier 300, showing more clearly that socket 340 has a T-shape, allowing a T-shape cross section embodiment of anchor 100 to be inserted and removed. FIG. 8b is a side view of carrier 300, showing that portal 310 is positioned near surface 320, wherein “near” means proximate to but not on or at the surface. It also depicts that portal 310 does extend through the width of carrier 300, allowing a user to insert a coupler through the carrier to join the carrier with a leash or lead.

To use the entire system, a user might follow these steps. First, join anchor 100 with a leash or lead using the methods herein. Next, join carrier 200 or 300 with a leash or lead using the methods described herein. Next, insert the distal end of anchor 100 through socket 240 or 340, continuing until one-quarter to three-quarters of the length of the anchor has gone through the socket. This allows the anchor to be held to the leash or lead at two points without requiring the user to carrier the anchor in a hand, pocket, or other inconvenient place. At this point, the user might attach the leash or lead to the animal and begin walking. When the user needs to pause and use both hands, the user might remove anchor 100 from carrier 200 or 300, leaving anchor coupled to the leash or lead at the anchor handle 110. Next, insert point 160 into the ground and continue until approximately one-half of the length of anchor 100 is in the ground. At this point the user can drop the leash or lead from the user's hands. When the user is ready to resume walking, handle 110 is used to remove anchor 100 from the ground, and the anchor is returned to carrier 200 or 300. It should be understood that many of these steps may be interchangeable without altering the function of the system.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A portable system for restraining an animal, comprising:
an anchor, the anchor further comprising:
a proximal end, wherein the proximal end includes a handle; and
a distal end, wherein the distal end tapers to a point; and
a carrier, the carrier further comprising:
a grip end, the grip end configured to mate with an animal leash; and
an anchor end, the anchor end configured to removably receive the anchor.

2. The portable system for restraining an animal in claim 1, wherein the anchor further comprises:
a T-shaped cross section.

3. The portable system for restraining an animal in claim 1, wherein the anchor further comprises:
a circular cross section.

4. The portable system for restraining an animal in claim 1, wherein the anchor further comprises:
a square cross section.

5. The portable system for restraining an animal in claim 1, wherein the anchor further comprises:
an x-shaped cross section.

6. The portable system for restraining an animal in claim 1, wherein the carrier further comprises:
an anchor end, the anchor end containing a cutout configured to removably receive the anchor.

7. The portable system for restraining an animal in claim 1, wherein the handle comprises a loop.

8. The portable system for restraining an animal in claim 1, wherein the grip end further comprises:
an open end and a closed end, wherein the area between the open end and the closed end contains a gap; and
a plurality of opposing teeth disposed throughout the gap between the open end and the closed end.

9. The portable system for restraining an animal in claim 1, wherein the grip end further comprises:
a substantially flat surface; and
a double-sided adhesive element, wherein one side of the adhesive is disposed on the substantially flat surface of the grip end.

10. The portable system for restraining an animal in claim 1, wherein the grip end further comprises:
a substantially flat surface; and
a double-sided adhesive element, wherein a first side of the adhesive is disposed on the substantially flat surface of the grip end, and a second side of the adhesive is covered by a removable film.

11. A portable system for restraining an animal, comprising:
an anchor, the anchor further comprising:
a proximal end, wherein the proximal end forms a loop;
a distal end, wherein the distal end tapers to a point; and
a T-shaped cross section; and
a carrier, the carrier further comprising:
a grip end with an open end and a closed end, wherein the distance between the open end and closed end contains a plurality of opposing nibs alternating with open space; and
an anchor end, the anchor end containing a T-shaped cutout configured to removably receive the anchor.

12. A method of temporarily restraining an animal, comprising:
coupling an animal leash with a handle of an anchor;
carrying the anchor in a carrier, the carrier disposed on a portion of the animal leash;
removing the anchor from the carrier;
inserting a tapered end of the anchor into a portion of ground;
removing the anchor from the ground; and
returning the anchor to the carrier disposed on the animal leash.
